(19) United States
(12) Patent Application Publication
(10) Pub. No.: US 2026/0079357 A1
(43) Pub. Date: Mar. 19, 2026

(54) ADJUSTABLE HEAD-MOUNTED DEVICE

(71) Applicant: Apple Inc., Cupertino, CA (US)

(72) Inventor: Paul X. Wang, Cupertino, CA (US)

(21) Appl. No.: 18/845,801

(22) PCT Filed: Mar. 23, 2023
(86) PCT No.: PCT/US2023/016120

§ 371 Date: Sep. 10, 2024

Related U.S. Application Data
(60) Provisional application No. 63/269,880, filed on Mar. 24, 2022.

(51) Int. Cl. G02C 11/04; G02B 27/01

(52) U.S. Cl. CPC G02C 11/04; G02B 27/0176; G02B 2027/0178

(57) ABSTRACT

A wearable electronic device can include one or more contact members that are adjustable or otherwise modular to enable movement of an eye box defined within a lens of the wearable electronic device relative to the wearer's pupil. The contact members can be at least partially disposed within a cavity or recess defined within a frame of the wearable electronic device and can be modular such that the member is removably coupled to the frame and can be replaced by a different member having a dissimilar size or shape. Alternatively, or additionally, the member can be adjustable relative to the frame such that the member extends a first distance relative to the frame in one configuration and a second distance different from the first distance in another configuration.

### CROSS-REFERENCE TO RELATED APPLICATIONS

This application is a national stage filing based off of PCT Application No. PCT/US2023/016120, filed Mar. 23, 2023, and entitled “ADJUSTABLE HEAD-MOUNTED DEVICE” and to U.S. Provisional Patent Application No. 63/269,880, filed 24 Mar. 2022, and entitled “ADJUSTABLE HEAD-MOUNTED DEVICE,” the entire disclosures of which are hereby incorporated by reference.

### FIELD

The described examples relate generally to wearable electronic devices. More particularly, the present examples relate to reconfigurable head-mounted devices, including smart or computer glasses.

### BACKGROUND

Head-mounted devices, such as computer glasses or smart glasses, are worn on a user's head and incorporate an optical display and computing capabilities. Computer glasses are typically supported on the user's head by support arms or a band that is connected to either side of the glasses. With the advent of computer glasses comes an increased demand for dynamic entertainment and functionality for wearers having a variety of physiological attributes. For example, head-mounted devices include electrical components, such as displays, speakers, and cameras, whose positioning needs to accommodate for a wide variety of variances in users (e.g., facial features, head shape, and ear position) and environments.

### SUMMARY

According to some aspects of the present disclosure, a wearable electronic device includes a frame, a lens coupled to the frame, a support arm coupled to the frame, a light emitter, and a modular contact member. The light emitter can be coupled to the support arm and configured to provide light to a portion of the lens. The modular contact member can be at least partially disposed within the frame and removably coupled to the frame.

In some examples, the modular contact member can be a first modular contact member that is replaceable by a second modular contact member. The second modular contact member can have a different size attribute than the first modular contact member. The second modular contact member can extend further from the frame than the first modular contact member.

In some examples, the modular contact member can be threadably fastened to the frame. In some examples, the modular contact member can be removably coupled to the frame by one or more magnets. In some examples, the modular contact member can extend a first distance from the frame in a first configuration and can be adjusted to extend a second distance from the frame in a second configuration. The second distance being different from the first distance.

In some examples, the frame can form a bridge defining a first surface and a second surface. The modular contact member can be a first modular contact member and the wearable electronic device can further include a second modular contact member. The first modular contact member can be disposed on the first surface. The second modular contact member can be disposed on the second surface. In some examples, the support arm can define a longitudinal axis and the light emitter can rotate about an axis of rotation that intersects the longitudinal axis. In some examples, the support arm can define a longitudinal axis and the light emitter can translate along an axis substantially perpendicular to the longitudinal axis.

According to some aspects, a wearable electronic device includes a frame, a lens coupled to the frame, a support arm coupled to the frame, a light emitter, and a contact member. The light emitter can be coupled to the support arm and configured to provide light to a portion of the lens. The contact member can be at least partially disposed within the frame. The contact member can extend a first distance from the frame in a first configuration and extend a second distance from the frame in a second configuration.

In some examples, the portion of the lens can be at a first position relative to the wearer's pupil in the first configuration. In some examples, the portion of the lens can be at a second position relative to the wearer's pupil in the second configuration. The second position can be different from the first position. In some examples, the wearable electronic device can also include an actuator coupled to the contact member. The actuator can bias the contact member between the first configuration and the second configuration. In some examples, the wearable electronic device can also include a sensor to detect a position of a pupil of the wearer relative to the portion of the lens. The contact member can be repositionable to substantially align the portion of the lens with the position of the pupil.

In some examples, the frame can form a bridge and the contact member can be at least partially disposed within the bridge. In some examples, the contact member can define an exterior surface configured to conform to a portion of a wearer's nose. In some examples, the wearable electronic device can also include a biasing element coupled to the contact member. The biasing element can bias the contact member to retract into the frame.

According to some aspects, a wearable electronic device can include a frame, a first lens coupled to the frame, a second lens coupled to the frame, a support arm coupled to the frame, a light emitter coupled to the support arm, and an adjustment mechanism coupled to the frame. The adjustment mechanism can vary a distance between the first lens and the second lens.

In some examples, the adjustment mechanism can move the first lens while the second lens remains stationary. In some examples, the adjustment mechanism can move the first lens and the second lens simultaneously. In some examples, the wearable electronic device can include a flexible material at least partially covering the frame. At least a portion of the adjustment mechanism can be concealed by the flexible material.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A shows a front view of a head-mounted device.

FIG. 1B shows a side view of the head-mounted device of FIG. 1A.

FIG. 2A shows a front view of a head-mounted device.

FIG. 2B shows a detail view of a head-mounted device.

FIG. 2C shows a perspective view of a contact member.

FIG. 3 shows a front view of a head-mounted device.

FIG. 4A shows a front view of a head-mounted device.

FIG. 4B shows a detail view of the head-mounted device of FIG. 4A.

FIG. 4C shows a front view of a head-mounted device.

FIG. 4D shows a detail view of the head-mounted device of FIG. 4C.

FIG. 4E shows a front view of a head-mounted device.

FIG. 5A shows a side view of a light emitter coupled to a head-mounted device in a first orientation.

FIG. 5B shows a side view of the light emitter coupled to the head-mounted device of FIG. 5A in a second orientation.

FIG. 5C shows a side view of a light emitter adjustably coupled to a head-mounted device.

FIG. 6A shows a top view of a head-mounted device.

FIG. 6B shows a side view of a head-mounted device including arms in a first orientation.

FIG. 6C shows a side view of the head-mounted display of FIG. 6B including arms in a second orientation.

### DETAILED DESCRIPTION

Reference will now be made in detail to representative examples illustrated in the accompanying drawings. It should be understood that the following descriptions are not intended to limit the examples to one preferred embodiment. To the contrary, it is intended to cover alternatives, modifications, and equivalents as can be included within the spirit and scope of the described examples as defined by the appended claims.

Head-mounted devices (HMDs), such as, computer glasses, smart glasses, virtual reality (VR) headsets, and augmented reality (AR) headsets are increasing in popularity due to a reduction in the size and weight of electronic components required to operate the HMDs, as well as advancements in functionality or utility of HMDs. An HMD should accommodate a variety of wearers, each having various physiological features that can be unique to the individual. For example, each wearer can have differing head shapes, nose shape, ear position, a distance between the wearers'eyes, a combination thereof, or other differing physiological features. In other words, each potential wearer of the HMD can have physical attributes differing from another potential wearer. This disparity in standardized physical attributes can be problematic when attempting to optimally align the output of the HMD (visual and/or audio output) to the wearer. For example, the HMD can define or form an eye box within one or more lenses which provides a visual or graphical output to the wearer. The visual or graphical output is optimal when the wearer's pupil is aligned or substantially aligned with the eye box of the HMD. Differing facial features, for example, can cause the eye box to be offset or misaligned with one wearer, and aligned when the HMD is worn by a different wearer. An HMD with one or more features which enable adjustment of the eye box relative to the wearer's eye can be advantageous and beneficial.

One aspect of the present disclosure relates to an HMD including one or more modular contact members that contact the user and which are adjustable or otherwise modular to move an eye box defined within a lens of the HMD relative to the wearer's pupil. The contact members can be at least partially disposed within a cavity or recess defined within a frame of the HMD and can be modular such that the contact member is removably coupled to the frame and can be replaced by a different contact member having a dissimilar size attribute or shape. Alternatively, or additionally, the contact member can be adjustable relative to the frame such that the contact member extends a first distance relative to the frame in one configuration and a second distance different from the first distance in another configuration.

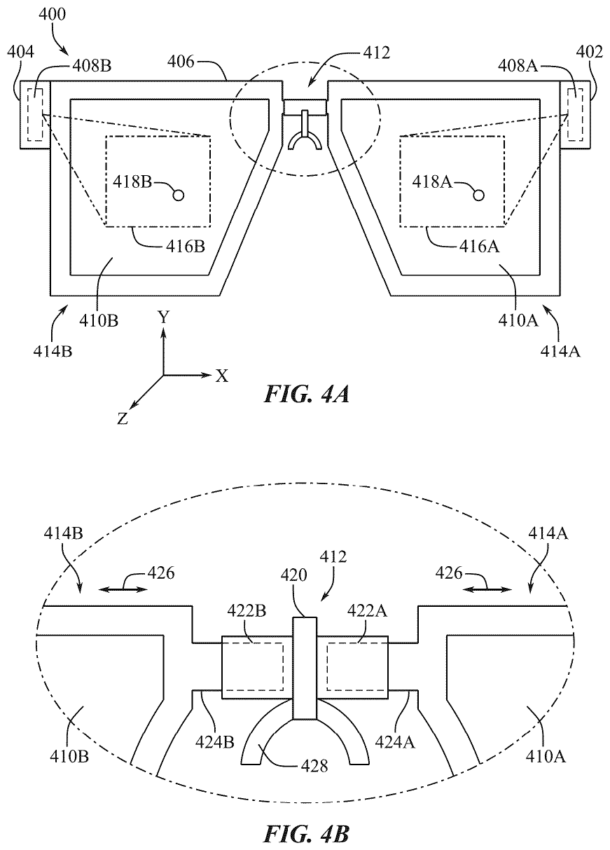

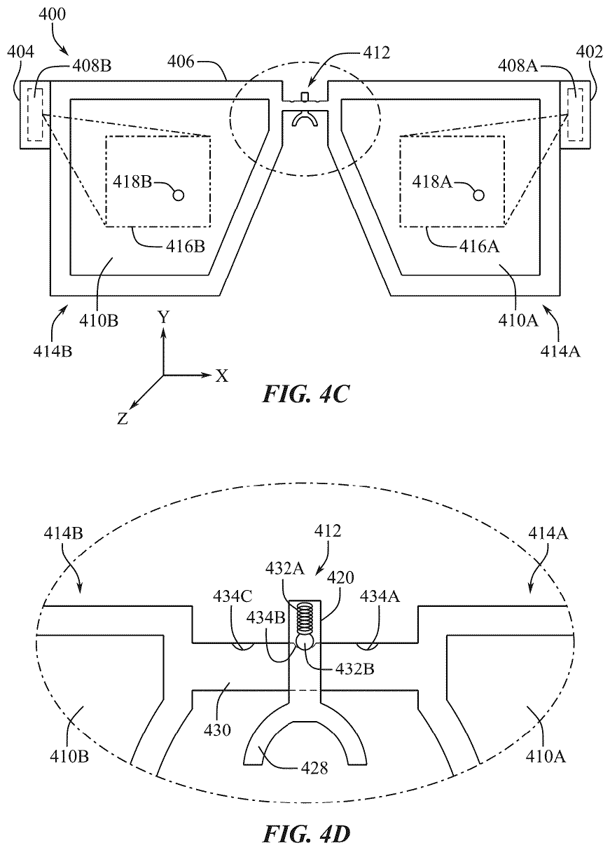

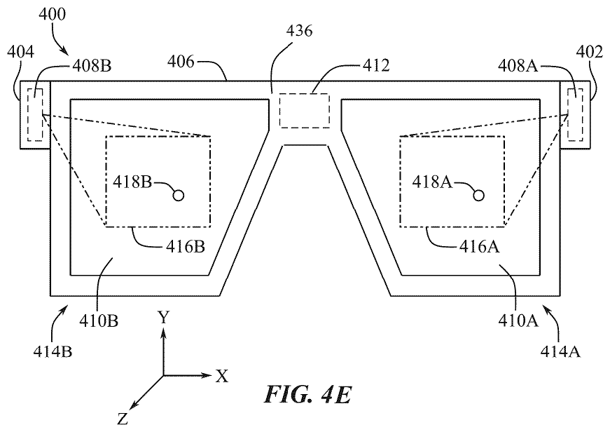

Another aspect of the present disclosure relates to adjusting or varying a position of the eye box relative to the wearer's pupil by adjusting the position of the frames and/or lenses relative to the wearer's pupil. For example, the HMD can include an adjustment mechanism configured to vary a distance between a first lens and a second lens of the HMD. The adjustment mechanism can cause the first lens to independently transition or move while the second lens remains stationary. In some examples, the adjustment mechanism can cause the second lens to independently transition or move while the first lens remains stationary. In some examples, the adjustment mechanism can cause the first and second lenses to move simultaneously. While specific examples of adjustment mechanisms are described in detail with reference to FIGS. 4A-4D, these examples should not limit the components, structures, and configurations that can be utilized to vary the distance between the first lens and the second lens of the HMD to align the wearer's pupil with the eye box of the HMD.

Another aspect of the present disclosure relates to adjusting or varying a light emitter of the HMD to alter a position of the eye box on the lens. For example, the light emitter can be coupled to an arm of the HMD and rotated about an axis or linearly translated along an axis to alter or offset the position of the eye box on the lens. In other words, the frame and lenses of the HMD can remain stationary on the wearer's head while the eye box is moved on the lens to better align the eye box with the wearer's pupil. In some examples, the light emitter can be rotated and linearly translated to alter or offset the position of the eye box on the lens.

Another aspect of the present disclosure relates to adjusting an orientation of one or more of the support arms of the HMD to move the eye box relative to the wearer's pupil. For example, the orientation of the support arms can be varied relative to one or more axes to reposition the frame and/or lenses on the wearer's face. Additionally, or alternatively, a lens of the HMD can be repositioned relative to the frame of the HMD to better align the eye box with the wearer's pupil. For example, one or more of the lenses can be linearly translatable within the frame of the HMD to better align the eye box with the wearer's pupil. Any of the aspects described herein can be combined or incorporated in any combination such that any single example can include one or more aspects or features of any other embodiment shown or described within the present disclosure.

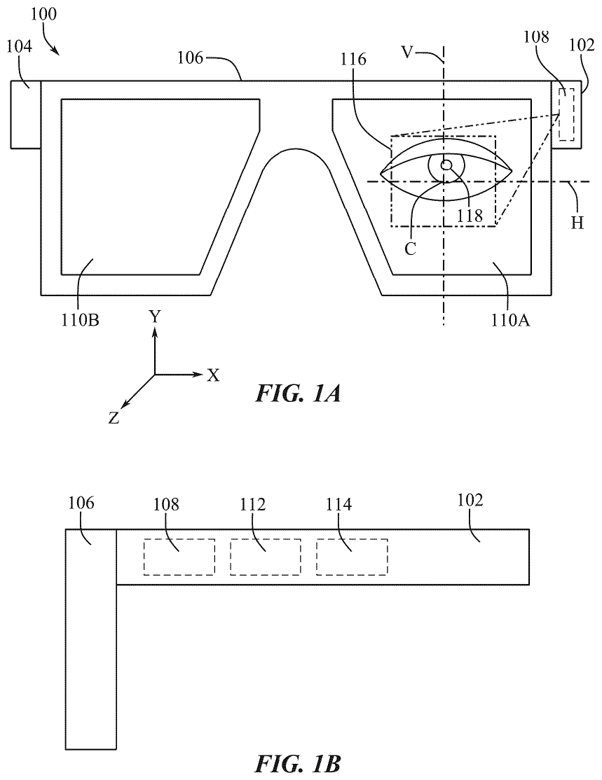

These and other examples are discussed below with reference to FIG. 1A-6C. However, those skilled in the art will readily appreciate that the detailed description given herein with respect to these Figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIGS. 1A and 1B show respective front and side views of a head-mounted device (HMD) 100. The HMD 100 can include a first support arm 102, a second support arm 104, a frame 106, a light emitter 108, and one or more lenses 110A, 110B at least partially disposed within the frame 106. The first and second support arms 102, 104 can be formed and shaped to at least partially extend around a wearer's head (not shown) to retain the HMD 100 on the user's head. For example, each of the first and second support arms 102, 104 can include a bend or curve correlating with a position of the wearer's respective ear while the HMD 100 is being worn. In some examples, the HMD can include a band that extends around the user's head to retain the HMD 100 to the wearer. In some examples, each of the first and second support arms can be pivotably coupled to the frame 106.

In some examples, one or more electronic components of the HMD 100 can be disposed within or on one or more of the first and second support arms 102, 104. For example, as shown in FIG. 1B, multiple electronic components, such as the light emitter 108, can be disposed on or within the first support arm 102. Other electronic components 112, 114 can alternatively, or additionally, be disposed within or on the first support arm 102. For example, the other electronic components 112, 114 can be one or more processors, displays, electric power supplies (e.g., batteries), logic boards, wireless communication modules, input modules, audio devices (e.g., speakers), memory devices, cameras, microphones, a combination thereof, or any other electronic component.

The light emitter 108 can provide light to at least a portion of the first lens 110A, the second lens 110B, or both the first and second lenses 110A, 110B. Additionally, or alternatively, each of the first lens 110A and the second lens 110B can be optically coupled to a dedicated light emitter configured to supply light rendering a graphical or visual output on the respective lens. The light provided by the light emitter 108 can be presented to the wearer at one or more of the lenses 110A, 110B as a visual or graphical output including one or more symbols, indicia, images, depictions, visual information, other visual output, or combinations thereof. The graphical or visual output can be provided to the exclusion of a view of a physical environment or in addition to (i.e., overlaid with) a physical environment. In some examples, the light emitter 108 can supply light to a waveguide or light pipes that transfers the light from the light emitter 108 to at least a portion of the first lens 110A. In some examples, the light emitter 108 can supply light to the first lens 110A by projecting light directly or indirectly onto the first lens 110A. Any mechanism now known or subsequently developed capable of transferring a graphical image to one or more of the first and second lenses 110A, 110B can be incorporated into the HMD 100.

The frame 106 can be coupled to one or more lenses (e.g., the first lens 110A and the second lens 110B). For example, as shown in FIG. 1A, the frame 106 can entirely encompass or surround the periphery of each of the first and second lenses 110A, 110B. In some examples, the frame 106 can surround only a portion of the periphery of first and second lenses 110A, 110B. In some examples, a singular lens can be coupled to the frame 106 and extend substantially between the first and second support arms 102, 104. In some examples, as shown in FIG. 1A, multiple lenses can be coupled to the frame 106.

The HMD 100 can include an eye box 116 that is formed or otherwise disposed on the lens (e.g., the first lens 110A). The eye box 116 can represent the portion of the first lens 110A that visual or graphical output (e.g., symbols, indicia, images, depictions, visual information, etc.) is visible by a wearer of the HMD 100. In some examples, while the HMD 100 is worn by a user, a center portion C of the eye box 116 can be misaligned with the user's pupil 118. For example, the user's pupil 118 can be horizontally offset from a vertical axis V and/or vertically offset from a horizontal axis H, the vertical axis V and the horizontal axis H intersecting the center portion C of the eye box 116. Misalignment of the pupil 118 and the eye box 116 can degrade or otherwise lessen the quality of user experience of the HMD 100, and induce other undesirable consequences, such as, blur, misalignment, double vision, or otherwise distorting or limiting the viewer's perception of the visual or graphical output of the HMD 100.

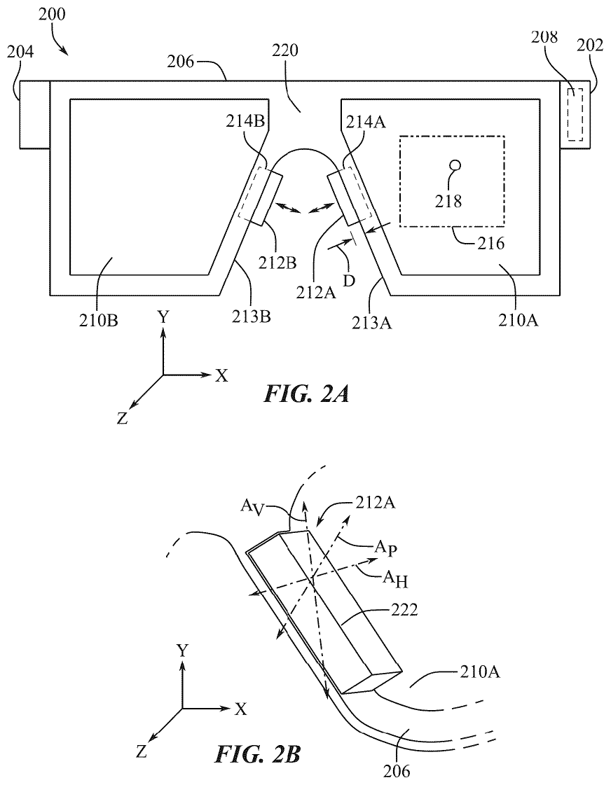

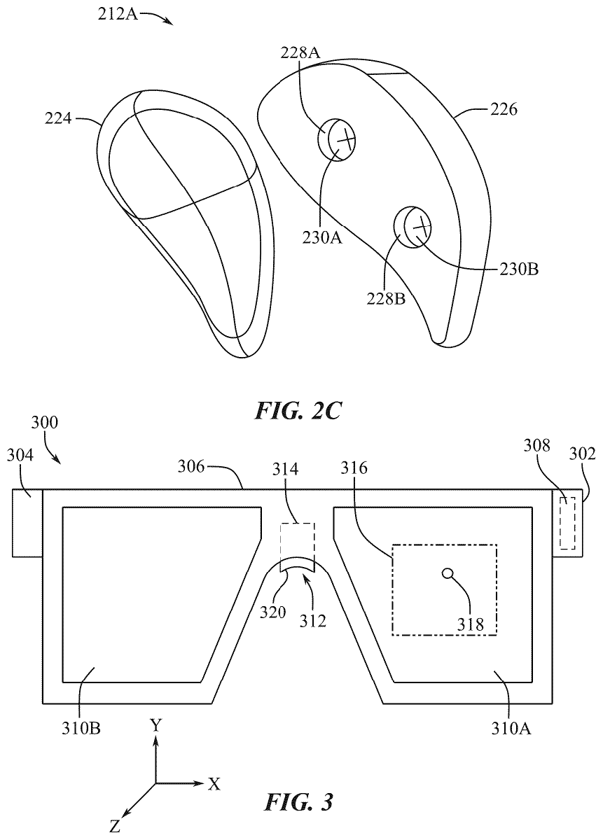

In some examples, the HMD can include one or more mechanisms, components, members, or other elements that enable the eye box to be repositioned relative to the user's pupil 118 to improve the quality of user experience and mitigate or eliminate undesirable consequences of misalignment. For example, the eye box 116 can be moved or transitions along the x-axis, the y-direction, the z-direction, or a combination thereof relative to the coordinate system shown in FIG. 1A. In other words, the HMD 100 can be adjusted relative to the wearer to provide superior functionality and a higher quality user experience. Examples of HMDs having one or more one or more mechanisms, components, members, or other elements capable of repositioning the eye box 116 relative to the wearer's pupil 118 are discussed below with reference to FIGS. 2A-6C. Any of the features or components described with reference to FIGS. 2A-6C can be combined or incorporated in any combination such that any single embodiment can include one or more features or components of any other embodiment shown or described with reference to FIGS. 2A-6C. The examples shown in FIGS. 2A-6C should therefore be viewed as demonstrative and not limiting with respect to the totality of structures and components that can be utilized to realize the aspects disclosed herein.

FIG. 2A shows a front view of an HMD 200. The HMD 200 can be substantially similar to, including some or all of the features of, the HMDs described herein, such as the HMD 100. For example, the HMD 200 can include a first support arm 202, a second support arm 204, a frame 206, a light emitter 208, and one or more lenses 210A, 210B at least partially disposed within the frame 206. The HMD 200 can also include contact members 212A, 212B disposed within respective recesses 214A, 214B of the frame 206. Each of the contact members 212A, 212B can be configured to adjustably displace the frame 206 relative to the nose of the wearer to align or otherwise reposition the eye box 216 relative to the wearer's pupil 218. For example, the frame 206 and lens 210A can be moved along the x-direction, the y-direction, the z-direction, or a combination thereof relative to the coordinate system shown in FIG. 2A. Each of the contact members 212A, 212B can be disposed on respective surfaces (e.g., first and second surfaces 213A, 213B) of a bridge 220 formed by the frame 206.

While a pair of contact members 212A, 212B are shown in FIG. 2A, less than two or more than two contact members can be incorporated into the HMD 200. Additionally, or alternatively, while the contact members 212A, 212B are shown in FIG. 2A in particular locations on the frame 206 (e.g., at particular locations on the bridge 220 defined by the frame 206), the contact members 212A, 212B can be disposed anywhere on the frame 206 or support arms 202, 204. For example, the HMD can include a single contact member disposed at the apex of the bridge 220 (see FIG. 3), or in other areas of the frame 206.

In some examples, one or both of the contact members 212A, 212B can be modular or replaceable within their respective recesses 214A, 214B, such that, the contact members 212A, 212B can be replaced with one or more other contact members having a size attribute, shape, contour, a combination thereof, or other attribute that differs from the contact members 212A, 212B. For example, the position of the wearer's pupil 218 can be adjusted relative to the eye box 216 by varying the distance D the contact member 212A extends from the frame 206. In some examples, the distance D can be a first distance before the contact member 212A is replaced by a contact member having a different attribute and a second distance after the contact member 212A is replaced by a contact member having a different attribute. The contact members 212A, 212B can be removably affixed or coupled within the recesses 214A, 214B of the frame 206, for example, by one or more magnets, fasteners, friction/interference-fit, adhesive, or any other mechanism for removably coupling the contact members 212A, 212B to the frame 206.

In some examples, one or both of the contact members 212A, 212B can be adjustable relative to the frame 206, such that, the contact members 212A, 212B can be moved or translated to move the frame 206 and lens 210A relative to the wearer's pupil 218. For example, the frame 206 can be repositionable relative to the wearer's pupil 218 along the x-direction, the y-direction, the z-direction, or a combination thereof relative to the coordinate system shown in FIG. 2A. Thus, the position of the wearer's pupil 218 can be adjusted relative to the eye box 216 by varying the distance D the contact member 212A extends from the frame 206. The contact member 212A can extend and retract along the x-direction, the y-direction, the z-direction, or a combination thereof relative to the coordinate system shown in FIG. 2A. In some examples, the distance D can be a first distance before the contact member 212A is adjusted and a second distance after the contact member 212A has been adjusted. The first distance can be greater than or less than the second distance. While the distance D is described with reference to contact member 212A, the description is equally applicable to contact member 212B. In some examples, a stepper motor, an actuator, a solenoid, an expandable and retractable bladder, a servo motor, a sliding wedge, a cam, a geared engagement, one or more rails, a combination thereof, or any other mechanism can be used to incrementally extend or retract one or more of the contact members 212A, 212B relative to the frame 206 and thereby vary the distance D. In some examples, one or more of the contact members 212A, 212B can be biased to retract into the frame 206. For example, the HMD 200 can include one or more springs, elastic elements, or other biasing elements (not shown) coupled to the contact member 212A, 212B.

FIG. 2B shows a detail view of the HMD 200. In some examples, the contact member 212A can be contoured to more uniformly contact the wearer's nose (not shown). For example, the contact member 212A can form a contoured surface 222. The contact member 212A can be repositionable or adjustable relative to the frame 206 in one more directions. For example, the contact member 212A can be repositionable along an axis A_{H} that extends substantially horizontal and parallel to the frame 206 (i.e., along the x-direction of the coordinate system shown in FIG. 2B). Translation of the contact member 212A along the axis A_{H} can cause the HMD 200 to horizontally shift relative to the wearer's pupil 218 and thereby enable horizontal alignment of the eye box 216 of the HMD 200 with the pupil 218. Additionally, or alternatively, the contact member 212A can be repositionable along an axis A_{V} that extends substantially vertical and parallel to the frame 206 (i.e., along the y-direction of the coordinate system shown in FIG. 2B). Translating along the axis A_{V} can cause the HMD 200 to vertically shift relative to the wearer's pupil 218 and thereby enable vertical alignment of the eye box 216 of the HMD 200 with the pupil 218. Additionally, or alternatively, the contact member 212A can be repositionable along an axis A_{P} that extends substantially perpendicular to the frame 206 (i.e., along the z-direction of the coordinate system shown in FIG. 2B). Translating along the axis A_{P} can vary a gap or space between the HMD 200 and the wearer's pupil 218, and thereby enable the eye box 216 of the HMD 200 to be gapped or spaced a desirable distance from the wearer's pupil 218. While this adjustability along axes A_{H}, A_{V}, and A_{P} is described with reference to contact member 212A shown in FIG. 2B, the description is equally applicable to the contact member 212B.

FIG. 2C shows a perspective view of the contact member 212A. In some examples, the contact member 212A can include a cover portion 224 and a body portion 226. The cover portion 224 can be formed from a flexible or semi-flexible material, such as, a material having polymers, organic fabrics, synthetic fabrics, or a combination thereof. The cover portion 224 can at least partially encompass the body portion 226. In some examples, the cover portion 224 can provide a less irritating interface on the wearer's skin, for example, by providing a cushioned or padded interface between the HMD 200 and the wearer. In some examples, the cover portion 224 can provide an interface between the HMD 200 and the wearer that has a relatively high coefficient off friction (greater than 1) which better retains the HMD 200 in a stationary position relative to the wearer. In some examples, the cover portion 224 can be replaceable or able to be cleaned between uses of the HMD 200. The cover portion 224 can be removably or permanently coupled to the body portion 226, for example, by adhesive, fasteners, friction-fit, an elastic force, molding, co-molding, interlocking features, a combination thereof, or any other mechanism for coupling the cover portion 224 to the body portion 226.

In some examples, the body portion 226 can be relatively more rigid than the cover portion 224. The body portion 226 can be formed or include a rigid or semi-rigid polymer, a metal, a ceramic, or a combination thereof. In some examples, the body portion 226 can be removably coupled to the frame 206. For example, the body portion 226 can include one or more through-holes 228A, 228B and be threadably coupled to the frame 206 by one or more fasteners 230A, 230B at least partially disposed within the respective through-holes 228A, 228B. In some examples, one or more magnets (not shown) can be disposed within the through-holes 228A, 228B and magnetically couple the contact member 212A to the frame 206. While the cover portion 224 and the body portion 226 have been described with reference to the contact member 212A shown in FIG. 2C, the description is equally applicable to the contact member 212B.

FIG. 3 shows a front view of a HMD 300. The HMD 300 can be substantially similar to, including some or all of the features of, the HMDs described herein, such as the HMDs 100, 200. For example, the HMD 300 can include a first support arm 302, a second support arm 304, a frame 306, a light emitter 308, and one or more lenses 310A, 310B at least partially disposed within the frame 306. The HMD 300 can also include a contact member 312 disposed within a recesses 314 defined by the frame 306. The contact member 312 can be configured to adjustably displace the frame 306 relative to the nose of the wearer to align or otherwise reposition the eye box 316 relative to the wearer's pupil 318. For example, the frame 306 and lenses 310A, 310B can be moved along the y-direction relative to the coordinate system shown in FIG. 3.

In some examples, the contact member 312 can be contoured to more uniformly contact or conform to the bridge of the wearer's nose (such as by a nose conforming surface) such that the weight of the HMD 300 is spread across a greater surface area. For example, the contact member 312 can form a contoured surface 320. In some examples, the HMD can include a single contact member (see FIG. 3), a pair or set of contact members (see FIG. 2A), or more than two contact members (e.g., a combination of the examples shown in FIGS. 2A and 3). A single contact member (e.g., contact member 312) can be coupled to the frame 306 and configured to move the HMD 300 is a single direction relative to the wearer and thereby enable alignment of the eye box 316 with the pupil 318 when the pupil 318 is only out of alignment in a single direction (e.g., vertically out of alignment along the y-direction of the coordinate system shown in FIG. 3).

FIG. 4A shows a front view of an HMD 400. The HMD 400 can be substantially similar to, and can include some or all of the features of, other HMDs described herein, such as the HMDs 100, 200, 300. For example, the HMD 400 can include a first support arm 402, a second support arm 404, a frame 406, one or more light emitters 408A, 408B, and one or more lenses 410A, 410B at least partially disposed within the frame 406. As shown in FIG. 4A, in some examples, the HMD 400, or any other HMD described herein, can include multiple light emitters. For example, a first light emitter 408A can be coupled to the first support arm 402 while a second light emitter 408B can be coupled to the second support arm 406. The first light emitter 408A can provide light to at least a portion of the first lens 410A and the second light emitter 408B can provide light to at least a portion of the second lens 410B. The light provided by the one or more light emitters 408A, 408B can be presented to the wearer at one or more of the lenses 410A, 410B as a visual or graphical output including one or more symbols, indicia, images, depictions, visual information, other visual output, or combinations thereof. The graphical or visual output can be provided to the exclusion of a view of a physical environment, or in addition to (i.e., overlaid with) a physical environment. In some examples, the one or more light emitters 408A, 408B can supply light to a waveguide or light pipes that transfer the light to at least a portion of the first lens 410A and/or second lens 410B.

In some examples, the HMD 400 can also include an adjustment mechanism 412 coupled to the frame 406. The adjustment mechanism 412 can be configured to adjustably displace respective portions 414A, 414B of the frame 406 relative to the wearer to align or otherwise reposition respective eye boxes 416A, 416B relative to the wearer's pupils 418A, 418B. For example, the adjustment mechanism 412 can vary a distance between the first lens 410A and the second lens 410B. The adjustment mechanism 412 can vary the distance between the first lens 410A and the second lens 410B manually (e.g., a user initiated adjustment), passively (e.g., an automatic adjustment made by the HMD based on, for example, detection of the wearer's pupil 418A in relation to the eye box 416A), or a combination thereof. For example, the HMD 400 can optionally include one or more sensors (not shown) to detect a positional relationship between the wearer's eye or a portion thereof and the HMD 400 or a portion thereof. In some examples, the adjustment mechanism 412 can reposition or move the first lens 410A while the second lens 410B remains stationary relative to the adjustment mechanism 412. In some examples, the adjustment mechanism 412 can reposition or move the first lens 410A and the second lens 410B simultaneously relative to the adjustment mechanism 412.

In some examples, at least a portion of the adjustment mechanism 412 can be covered or enveloped by a flexible material 436 (see FIG. 4E) at least partially concealing the adjustment mechanism 412 from the wearer. For example, a flexible material, such as, an elastic polymer or fabric can be coupled to the frame 406 and at least partially conceal the adjustment mechanism 412. In some examples, the flexible material 436 can deform (e.g., elastic deformation) to continuously span between the first portion 414A of the frame 406 and the second portion 414B of the frame 406 regardless of a spatial change to the distance between the first portion 414A and the second portion 414B induced on the frame 406 by the adjustment mechanism 412. In other words, the flexible material 436 can cover or conceal the adjustment mechanism 412 before, during, and after the adjustment mechanism 412 has modified the HMD 400 to better align the wearer's pupils 418A, 418B with the respective eye boxes 416A, 416B (see FIG. 4E).

FIG. 4B shows a detail view of the HMD 400 shown in FIG. 4A including one non-limiting example of the adjustment mechanism 412. In some examples, the adjustment mechanism 412 can enable the first portion 414A of the frame 406, the second portion 414B of the frame 406, or a combination thereof to translate or move relative to the adjustment mechanism 412. For example, the adjustment mechanism 412 can be adjustably and independently coupled to the first portion 414A and the second portion 414B such that the first portion 414A and/or the second portion 414B can move relative to the adjustment mechanism 412. In some examples, the adjustment mechanism 412 can include an intermediate portion 420 defining one or more cavities or channels 422A, 422B configured to removably receive respective protrusions 424A, 424B of the first and second portions 414A, 414B. Each of the respective protrusions 424A, 424B can be moveably coupled within the respective channels 422A, 422B, such that, the first and second portions 414A, 414B of the frame 406 can be laterally displaced along a horizontal axis (indicated by arrows 426) relative to the intermediate portion 420. Each of the respective protrusions 424A, 424B can be adjustable or moveable relative to their channel 422A, 422B by a stepper motor, an actuator, a solenoid, an expandable and retractable bladder, a servo motor, a sliding wedge, a cam, a geared engagement, one or more rails, a combination thereof, or any other mechanism capably of incrementally extending or retracting the respective protrusions 424A, 424B relative to the intermediate portion 420. In some examples, the adjustment mechanism 412 can include a contact member 428 contoured to more uniformly contact or conform to the bridge of the wearer's nose (such as by a nose conforming surface). The contact member 428 can remain stationary relative to the intermediate portion 420 or can be repositionable to displace the HMD 400 in one or more directions relative to the wearer's pupil 418A, 418B. For example, the contact member 428 can be substantially similar to, including some or all of the features of, the contact members described herein, such as the contact member 312.

FIGS. 4C and 4D show the HMD 400 having another example of the adjustment mechanism 412 configured to adjustably reposition the frame 406 relative to the wearer's pupil 418A, 418B to better align the eye box 416A, 416B with the wearer's pupil 418A, 418B. In some examples, at least a portion of the adjustment mechanism 412 can be covered or enveloped by a flexible material at least partially concealing the adjustment mechanism 412 from the wearer. For example, a flexible material, such as, an elastic polymer or fabric can be coupled to the frame 406 and at least partially conceal the adjustment mechanism 412 (see FIG. 4E).

FIG. 4D shows a detail view of the HMD 400 shown in FIG. 4C including another example of the adjustment mechanism 412. In some examples, the adjustment mechanism 412 can include an intermediate portion 420 that is repositionable along a bridge 430 of the frame 406 to adjustably reposition the frame 406 relative to the wearer's pupil 418A, 418B. For example, the adjustment mechanism 412 can include a biasing element 432A (e.g., a spring) and an interlock 432B (e.g., a ball bearing) adjustably retaining the intermediate portion 420 at one of multiple discrete interlock features 434A-C (e.g., recesses) disposed along the bridge 430. Additionally, or alternatively, the adjustment mechanism 412 can include one or more rails, gears, teeth, fasteners, motors such as stepper motors, dovetails, a combination thereof, or any other feature to adjustably retain the intermediate portion 420 at a desired position along the bridge 430. In some examples, the adjustment mechanism 412 can include the contact member 428 contoured to more uniformly contact or conform to the bridge of the wearer's nose (such as by a nose conforming surface). The contact member 428 can remain stationary relative to the intermediate portion 420 or can be repositionable to displace the HMD 400 in one or more directions relative to the wearer's pupil 418A, 418B. For example, the contact member 428 can be substantially similar to, and/or including some or all of the features of, the contact members described herein, such as the contact member 312.

FIG. 4E shows the adjustment mechanism 412 covered or enveloped by the flexible material 436, such that, the adjustment mechanism 412 is at least partially concealed from the wearer. For example, the flexible material 436 can be an elastic polymer or fabric can be coupled around an entirety or a portion of the frame 406. In some examples, the flexible material 436 can deform (e.g., elastic deformation) to continuously span between the first portion 414A of the frame 406 and the second portion 414B of the frame 406 regardless of a spatial change to the distance between the first portion 414A and the second portion 414B induced on the frame 406 by the adjustment mechanism 412. In other words, the flexible material 436 can cover or conceal the adjustment mechanism 412 before, during, and after the adjustment mechanism 412 has modified the HMD 400 to better align the wearer's pupils 418A, 418B with the respective eye boxes 416A, 416B.

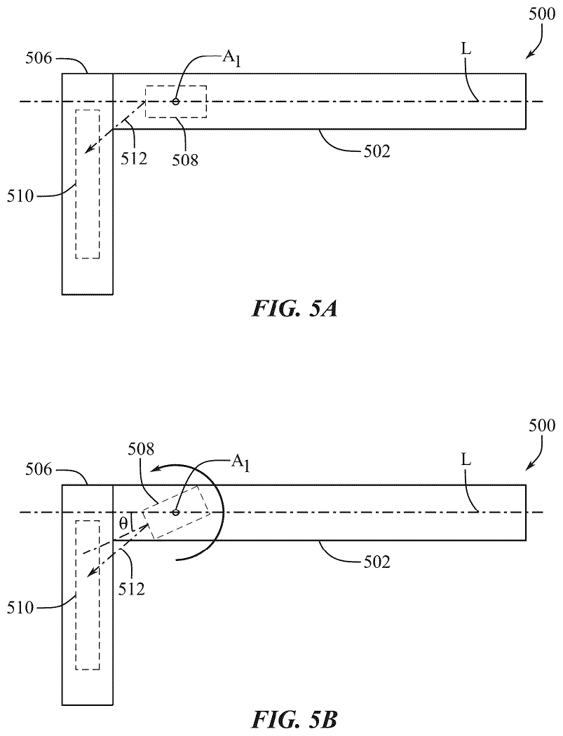

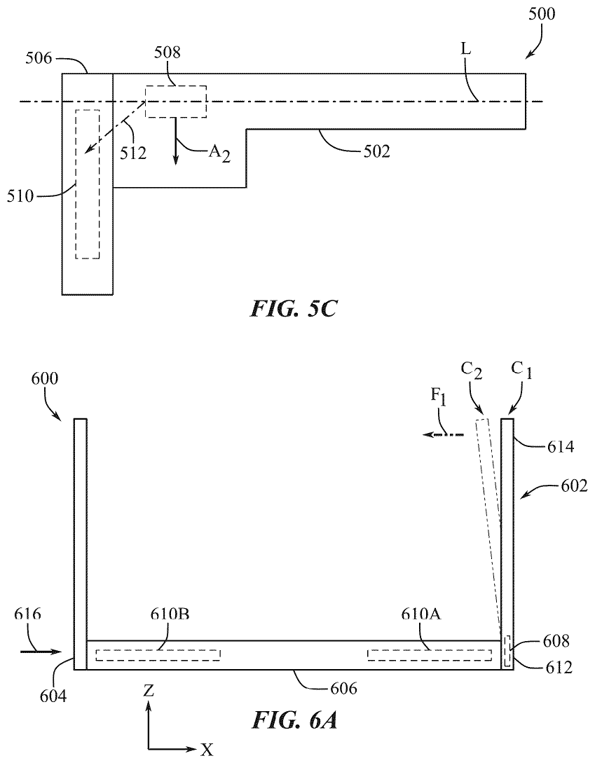

FIGS. 5A and 5B show side views an HMD 500. The HMD 500 can be substantially similar to, and can include some or all of the features of, other HMDs described herein, such as the HMDs 100, 200, 300, 400. For example, the HMD 500 can include a first support arm 502, a second support arm (not shown), a frame 506, one or more light emitters 508, and one or more lenses 510 at least partially disposed within the frame 506. In some examples, the light emitter 508 can rotate about an axis of rotation A₁ (shown as extending into/out of the figure) that intersects a longitudinal axis L defined by the first support arm 502. In FIG. 5A, the light emitter 508 is illustrated in a first configuration or first orientation. In FIG. 5B, the light emitter 508 is illustrated in a second configuration or second orientation wherein the light emitter 508 has been rotated about the axis of rotation A₁. For example, the light emitter 508 can be rotated an angle θ, such that, light 512 provided by the light emitter 508 can propagate toward or otherwise be presented to the wearer at a different position on the lens 510 in the second configuration than the first configuration. The angle θ can be greater than about 3 degrees, between about 3 degrees and about 5 degrees, between about 5 degrees and about 10 degrees, between about 10 degrees and about 15 degrees, between about 15 degrees and 20 degrees, between about 20 degrees and about 25 degrees, or greater than 25 degrees.

In some examples, changing the orientation of the light emitter 508 by the angle θ can cause the light emitter 508 to provide or supply light to a different portion of the lens 510 (e.g., cause the eye box to be illuminated at a different position on the lens 510) than the portion of the lens 510 that would be illuminated in a non-rotated configuration (see FIG. 5A). For example, rotating or reorienting the light emitter 508 can cause light 512 to be emitted or projected directly onto the lens 510 in a different position. Additionally, or alternatively, the light 512 can be supplied to a waveguide or light pipes that transfer the light 512 to a different portion of the lens 510 than the first configuration shown in FIG. 5A.

FIG. 5C shows a side view of the light emitter 508 coupled to the HMD 500, such that, the light emitter 508 can translate or slide along an axis A₂ to adjustably provide or supply light 512 to differing portions of the lens 510 and better align the eye box (not shown) with the wearer's pupil. For example, the HMD 500 can include a stepper motor, an actuator, a solenoid, an expandable and retractable bladder, a motor such as a servo motor, a sliding wedge, a cam, a geared engagement, one or more rails, a combination thereof, or any other mechanism to incrementally translate the light emitter 508 along the axis A₂. The axis A₂ can be perpendicular or substantially perpendicular to the longitudinal axis L defined by the first support arm 502. In some examples, the light emitter 508 can translate or move along the axis A₂ a distance or length to adjustably provide or supply light 512 to differing portions of the lens 510. For example, the distance or length can be greater than about 3 mm, between about 3 mm and about 5 mm, between about 5 mm and about 10 mm, between about 10 mm and about 15 mm, between about 15 mm and 20 mm, between about 20 mm and about 25 mm, or greater than 25 mm.

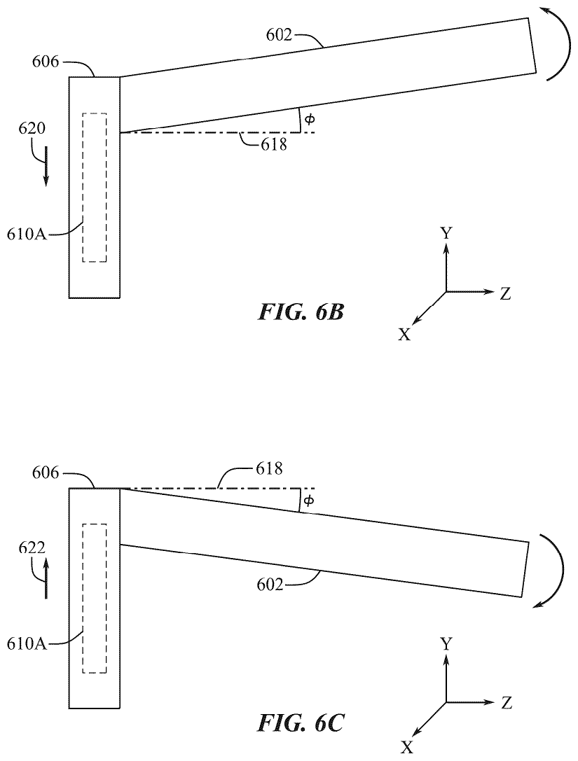

FIG. 6A shows a top view of an HMD 600. The HMD 600 can be substantially similar to, and include some or all of the features of, other HMDs described herein, such as the HMDs 100, 200, 300, 400, 500. For example, the HMD 600 can include a first support arm 602, a second support arm 604, a frame 606, one or more light emitters 608, and one or more lenses 610A, 610B at least partially disposed within the frame 606. The first support arm 602 can include a proximal end 612 and a distal end 614. The proximal end 612 can be coupled (e.g., rotatably coupled) to the frame 606. In some examples, the distal end 614 can be rotated or transitioned such that the position of the frame 606 is adjusted relative to the wearer to better align an eye box on the lens 610A with a pupil of the wearer. For example, a motor, gear mechanism, solenoid, or other mechanism can actuate to cause the distal end 614 of the first support arm 602 to displace from a first configuration C₁ to a second configuration C₂ (see FIG. 6A). In the second configuration C₂, the first arm 602 can induce a force F₁ on the wearer's head, such that, the frame 602 is displaced in a direction (represented by arrow 616 and along the x-direction relative to the coordinate system shown in FIG. 6A) to better align an eye box on the lens 610A with a pupil of the wearer. While the force F₁ is described in correlation with the first support arm 602, the second support arm 604 can alternatively, or additionally, induce a force that displaces the frame 606 to better align an eye box on the lens 610A with a pupil of the wearer. The example illustrated in FIG. 6A is merely one non-limiting representation of this aspect of the present disclosure. In some examples, the force F₁ can additionally, or alternatively, be applied by the second arm 604 in the same direction shown in FIG. 6A or a different direction (e.g., applied in an opposite direction, such as, toward the first support arm 602.).

In some examples, one or more of the first and second support arms 602, 604 can be coupled (e.g., pivotably coupled) to the frame 606 such that one or more of the first and second support arms 602, 604 can additionally, or alternatively, rotate or translate relative to the frame 606 to displace the distal end 614 in the y-direction relative to the coordinate system shown in FIGS. 6A-6C. For example, FIGS. 6B and 6C show side views of the HMD 600 including one or more of the first and second support arms 602, 604 in first and second orientations, respectively. When the first support arm 602 is in the first configuration (see FIG. 6B), the first support arm 602 can be disposed at an angle Φ above (e.g., in the positive y-direction) an original configuration of the first support arm 602 (shown as line 618). Rotating or transitioning the first support arm 602 at an angle Φ above (e.g., in the positive y-direction) the original configuration of the first support arm 602 (shown as line 618) can cause the frame 606 to translate or transition in the negative y-direction (as illustrated by arrow 620) to enable better alignment of the wearer's pupil(s) to an eye box formed on the lens 610A. When the first support arm 602 is in the second configuration (see FIG. 6C), the first support arm 602 can be disposed at the angle Φ below (e.g., in the negative y-direction) the original configuration of the first support arm 602 (shown as line 618). Rotating or transitioning the first support arm 602 at an angle Φ below (e.g., in the negative y-direction) the original configuration of the first support arm 602 (shown as line 618) can cause the frame 606 to translate or transition in the positive y-direction (as illustrated by arrow 622) to enable better alignment of the wearer's pupil(s) to the eye box formed on the lens 610A. While the first support arm 602 is referenced above, the second support arm 604 can be additionally, or alternatively, transitioned or displaced as described above with reference to FIGS. 6A-6C.

The computer glasses described herein can be used in conjunction with a wide variety of computer based reality. For example, computer-generated reality (CGR) environment refers to a wholly or partially simulated environment that people sense and/or interact with via an electronic system. The glasses can be used in a mixed reality environment. In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). Further, an augmented virtuality (AV) environment refers to a simulated environment in which a virtual or computer generated environment incorporates one or more sensory inputs from the physical environment.

Personal information data, when gathered using authorized and well established secure privacy policies and practices, can be used with the various embodiments described herein. The disclosed technology remains operable without such personal information data.

It will be understood that the details of the present systems and methods above can be combined in various combinations and with alternative components. The scope of the present systems and methods will be further understood by the following claims.

What is claimed is:

1. A wearable electronic device, comprising:
a frame;
a lens coupled to the frame;
a support arm coupled to the frame;
a light emitter coupled to the support arm, the light emitter providing light to a portion of the lens; and
a contact member at least partially disposed within the frame, the contact member being removably coupled to the frame.

2. The wearable device of claim 1, wherein:
the contact member comprises a first modular contact member having a first size attribute and a second modular contact member having a second size attribute different from the first size attribute; and
the first modular contact member is replaceable by the second modular contact member.

3. The wearable device of claim 2, wherein the second modular contact member extends further from the frame than the first modular contact member.

4. The wearable device of claim 1, wherein the contact member is threadably fastened to the frame.

5. The wearable device of claim 1, wherein the contact member is removably coupled to the frame by a magnet.

6. The wearable device of claim 1, wherein the contact member extends a first distance from the frame in a first configuration and extends a second distance from the frame in a second configuration, the second distance being different from the first distance.

7. The wearable device of claim 1, wherein:
the lens comprises a first lens and further comprising a second lens coupled to the frame;
the frame forms a bridge between the first lens and the second lens, the frame defining a first surface and a second surface;
the contact member comprises a first modular contact member and a second modular contact member;
the first modular contact member is disposed on the first surface; and
the second modular contact member is disposed on the second surface.

8. The wearable device of claim 1, wherein:
the support arm defines a longitudinal axis; and
the light emitter rotates about an axis of rotation that intersects the longitudinal axis.

9. The wearable device of claim 1, wherein:
the support arm defines a longitudinal axis; and
the light emitter translates along an axis substantially perpendicular to the longitudinal axis.

10. A wearable electronic device, comprising:
a frame;
a lens coupled to the frame;
a support arm coupled to the frame;
a light emitter coupled to the support arm, the light emitter configured to provide light to a portion of the lens; and
a contact member at least partially disposed within the frame and extending a first distance from the frame in a first configuration and extending a second distance from the frame in a second configuration.

11. The wearable device of claim 10, wherein:
the portion of the lens is disposed at a first position relative to a pupil of a wearer of the wearable electronic device in the first configuration; and
the portion of the lens is disposed at a second position relative to the pupil of the wearer of the wearable electronic device in the second configuration.

12. The wearable device of claim 10, further comprising an actuator coupled to the contact member and biasing the contact member between the first configuration and the second configuration.

13. The wearable device of claim 10, further comprising a sensor to detect a position of a pupil of a wearer relative to the portion of the lens.

14. The wearable device of claim 10, wherein:
the frame defines a bridge; and
the contact member is at least partially disposed within the bridge.

15. The wearable device of claim 10, wherein the contact member comprises a nose conforming surface.

16. The wearable device of claim 10, further comprising a biasing element coupled to the contact member, wherein the contact member is biased to retract into the frame.

17. A wearable electronic device, comprising:
a frame;
a first lens coupled to the frame;
a second lens coupled to the frame;
a support arm coupled to the frame;
a light emitter coupled to the support arm, the light emitter to provide light to a portion of the first lens; and
an adjustment mechanism coupled to the frame and configured to adjust a distance between the first lens and the second lens.

18. The wearable electronic device of claim 17, wherein the adjustment mechanism moves the first lens relative to the frame.

19. The wearable electronic device of claim 17, wherein the adjustment mechanism moves the first lens and the second lens relative to the frame.

20. The wearable electronic device of claim 17, further comprising a flexible material at least partially covering the frame, wherein at least a portion of the adjustment mechanism is concealed by the flexible material.
